(19) United States
(12) Patent Application Publication
(10) Pub. No.: US 2015/0032922 A1
(43) Pub. Date: Jan. 29, 2015

(54) COMPUTER SYSTEM, METHOD OF PROCESSING THE SAME, AND COMPUTER READBLE MEDIUM

(71) Applicant: NEC Corporation, Minato-ku, Tokyo (JP)

(72) Inventor: Kazuhisa Ishizaka, Tokyo (JP)

(73) Assignee: NEC CORPORATION, Minato-ku, Tokyo (JP)

(21) Appl. No.: 14/373,954

(22) PCT Filed: Dec. 21, 2012
(86) PCT No.: PCT/JP2012/008188

§ 371 Date: Jul. 23, 2014

(30) Foreign Application Priority Data
Feb. 28, 2012 (JP) 2012-041900

(51) Int. Cl. G06F 3/06

(52) U.S. Cl. CPC G06F 3/0608; G06F 3/0655; G06F 3/067
USPC 710/74

(57) ABSTRACT

A computer system 10 includes a host means 110, an extension means 120 to extend functionality of the host means 110, and a common communication means 130 having a function of passing data. The host means 110 includes a storage means 111 and a processing means 112, the storage means 111 storing data and the processing means 112 processing the stored data. The extension means 120 is connected to the host means 110 to extend functionality of the host means 110, the extension means 120 including a storage means 121 and a processing means 122, the storage means 121 storing data and the processing means 122 processing the stored data. The common communication means 130 has a function of passing data between threads in the host means 110. The common communication means 130 has a function of passing data between a thread in the host means 110 and a thread in the extension means 120.

### TECHNICAL FIELD

The present invention relates to a computer system in which the productivity in the development of a program is improved by simplifying the program, a method of processing the computer system, and a program.

### BACKGROUND ART

One processing method to achieve image processing and the like by software includes pipeline processing, in which a plurality of processes are connected in the form of a pipeline to perform processing while sequentially flowing data. In the pipeline processing, a preceding process and the following process can be performed on different pieces of data at the same time or the same process can be performed on a plurality of different pieces of data at the same time. Therefore, in the pipeline processing, a multi-core processor including a plurality of processor cores is used to perform processes that can be executed at the same time in parallel, thereby improving the processing performance.

In a shared memory multi-core processor, which is the current mainstream one, threads have been used as a method of performing parallel processing. According to this method, a plurality of threads in one process can be operated on different processor cores. It is known, however, that, since the memory space is shared, programming for the parallel processing is relatively easy. In the above pipeline processing, parallel processing can be achieved by causing different threads to execute respective processes in the pipeline.

In general, the greater the number of cores included in a processor is, the higher the performance of the program is that performs parallel processing by the plurality of threads. Therefore, one method to improve the processing performance may be replacing an existing computer with a computer equipped with a processor with a larger number of cores. This method causes, however, a problem that it requires operations involved in replacing the computer. Another method is thus required to improve the processing performance without replacing the computer.

Meanwhile, one known method for improving the processing performance of a computer system without replacing an existing computer or using a plurality of computers is a method of connecting an expansion card on which a processor is mounted to an expansion bus of a computer (e.g., see patent literature 1). According to this method, the processor on the expansion card is efficiently used in addition to the processor originally included in the computer system, whereby the whole processing performance can be improved. In this specification, such an expansion card is called an accelerator, whereas the original computer system is called a host system (or simply called a host).

In general, it is known that the use of an accelerator makes the development of the program complicated. It is thus difficult to improve the performance of the pipeline processing using an accelerator. In related accelerators, an increase in the speed of specific processing such as graphics processing or floating-point operations has been focused on. The program for an accelerator thus needs to be described in a special programming language different from the program in the host, which makes the development of the program difficult.

Meanwhile, in recent years, a multi-core accelerator and the like, which is provided with more versatile processor cores to achieve high performance, have been used. Such an accelerator has high compatibility in programming language with a host processor.

Another factor making the development of the program when accelerators are used complicated is a problem due to data transfer between a host and an accelerator. In general, the data transfer speed of an expansion bus which is connected to an accelerator is lower than that of a memory bus which is connected to a processor and a memory. Typically, the accelerator thus includes its own memory used by its own processor (e.g., see patent literature 2 and 3). Therefore, in a system that includes an accelerator, a host processor and an accelerator processor use different memory spaces. Thus, data cannot be directly transmitted and received through a memory between programs operated in the host and the accelerator as in a shared memory multi-core, and dedicated data transfer means needs to be used instead. When pipeline processing is performed using a plurality of threads in a process, for example, data is transferred between processes through a shared memory. Meanwhile, dedicated data transfer means is used between the host and the accelerator.

### CITATION LIST

### Patent Literature

Patent literature 1: Japanese Unexamined Patent Application Publication No. 2011-243055
Patent literature 2: Japanese Unexamined Patent Application Publication No. 2011-065650
Patent literature 3: Japanese Unexamined Patent Application Publication No. 2010-061648

### SUMMARY OF INVENTION

### Technical Problem

Assume here a case shown in FIG. 19, for example, in which, in pipeline processing configured by three processes of a process A, a process B, and a process C, the process B is executed using a plurality of threads in a host and an accelerator. Further, assume that processes are connected using queues and the accelerator is called using language extension for accelerators. In this case, as shown in FIG. 19, data is transmitted and received using a queue between the process A and the process B in the host, whereas a dedicated data transfer unit is used between the processes A and C in the host and the process B in the accelerator. In this way, when data parallel processing is performed using the host and the accelerator, means for transmitting and receiving data differs between the case in which data is transferred in the host and the case in which data is transferred between the host and the accelerator. This complicates the program, which causes a problem that the productivity in regard to the development of the program is lowered.

The present invention has been made in order to solve the above problems, and aims to provide a computer system in which the productivity in regard to the development of a program is improved by simplifying the program, a method of processing the computer system, and a program.

### Solution to Problem

One exemplary aspect of the present invention to achieve the above object is a computer system including:

host means including storage means and processing means, the storage means storing data and the processing means processing the stored data; and

extension means connected to the host means to extend functionality of the host means, the extension means including storage means and processing means, the storage means storing data and the processing means processing the stored data, in which

the computer system includes common communication means, the common communication means having a function of passing data between threads in the host means and a function of passing data between a thread in the host means and a thread in the extension means.

Another exemplary aspect of the present invention to achieve the above object may be a method of processing a computer system, the computer system including:

host means including storage means and processing means, the storage means storing data and the processing means processing the stored data; and

extension means connected to the host means to extend functionality of the host means, the extension means including storage means and processing means, the storage means storing data and the processing means processing the stored data, the method including the steps of:

passing data between threads in the host means; and

passing data between a thread in the host means and a thread in the extension means.

Another exemplary aspect of the present invention to achieve the above object may be a program of a computer system, the computer system including:

host means including storage means and processing means, the storage means storing data and the processing means processing the stored data; and

extension means connected to the host means to extend functionality of the host means, the extension means including storage means and processing means, the storage means storing data and the processing means processing the stored data, the program causing a computer to execute the following processing of:

passing data between threads in the host means; and

passing data between a thread in the host means and a thread in the extension means.

### Advantageous Effects of Invention

According to the present invention, it is possible to provide a computer system in which the productivity in regard to the development of a program is improved by simplifying the program, a method of processing the computer system, and a program.

### BRIEF DESCRIPTION OF DRAWINGS

FIG. 1 is a functional block diagram of a computer system according to one exemplary embodiment of the present invention;

FIG. 2 is a block diagram showing one example of a schematic hardware configuration of a computer system according to a first exemplary embodiment of the present invention;

FIG. 3 is a block diagram showing one example of a schematic software configuration of the computer system according to the first exemplary embodiment of the present invention;

FIG. 4 is a block diagram showing one example of a schematic software configuration of a computer system according to a second exemplary embodiment of the present invention;

FIG. 5 is a block diagram showing a schematic hardware configuration of a computer system according to a third exemplary embodiment of the present invention;

FIG. 6 is a block diagram showing one example of a software configuration of the computer system according to the third exemplary embodiment of the present invention;

FIG. 7 is a block diagram showing one example of a schematic configuration of a computer system according to a fourth exemplary embodiment of the present invention;

FIG. 8 is a block diagram showing one example of a software configuration of the computer system according to the fourth exemplary embodiment of the present invention including processes generated from a source code, and mainly shows a configuration of a host;

FIG. 9 is a block diagram showing one example of the software configuration of the computer system according to the fourth exemplary embodiment of the present invention, and mainly shows a configuration of an accelerator;

FIG. 10 is a diagram for describing one example of pipeline processing of a computer system according to a fifth exemplary embodiment of the present invention;

FIG. 11 is a diagram showing one example of a structure of data passed between a process A and a process B in the C language structure;

FIG. 12 is a diagram showing one example of a source code of a program used in the fifth exemplary embodiment of the present invention;

FIG. 13 is a diagram for describing a host and an accelerator according to the fifth exemplary embodiment of the present invention;

FIG. 14 is a diagram for describing a common communication unit according to the fifth exemplary embodiment of the present invention;

FIG. 15 is a diagram showing one example of a pipeline configured during a process in the host by a pipeline construction unit according to the fifth exemplary embodiment of the present invention;

FIG. 16 is a diagram showing one example of a pipeline constructed during a process in the accelerator;

FIG. 17 is a diagram showing one example of a whole connection configuration of the computer system according to the fifth exemplary embodiment of the present invention;

FIG. 18A is a diagram showing one example of a case in which processing is performed only by a thread on a host;

FIG. 18B is a diagram showing one example of a case in which parallel processing is performed by threads on a host and an accelerator; and

FIG. 19 is a diagram showing one example of related processing between a host and an accelerator.

### DESCRIPTION OF EMBODIMENTS

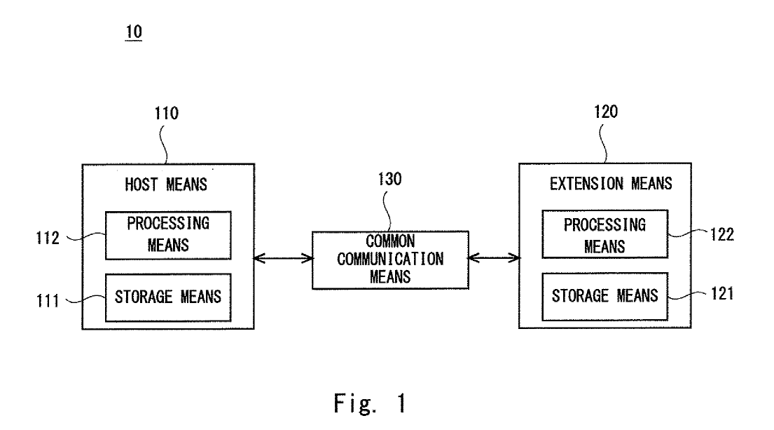

Exemplary embodiments of the present invention will be described hereinafter with reference to the drawings. FIG. 1 is a functional block diagram of a computer system according to one exemplary embodiment of the present invention. A computer system 10 according to this exemplary embodiment includes a host means 110, an extension means 120 connected to the host means 110 to extend the functionality of the host means 110, and a common communication means 130 for passing data between the host means 110 and the extension means 120. The host means 110 includes a storage means 111 and a processing means 112 and the extension means 120 includes a storage means 121 and a processing means 122. The storage means 111 and 121 store data and the processing means 112 and 122 process the stored data.

The common communication means 130 has a further function of passing data between threads in the host means 110 and a function of passing data between a thread in the host means 110 and a thread in the extension means 120. This simplifies the program of the computer system 10, thereby improving the productivity in regard to the development of the program.

### First Exemplary Embodiment

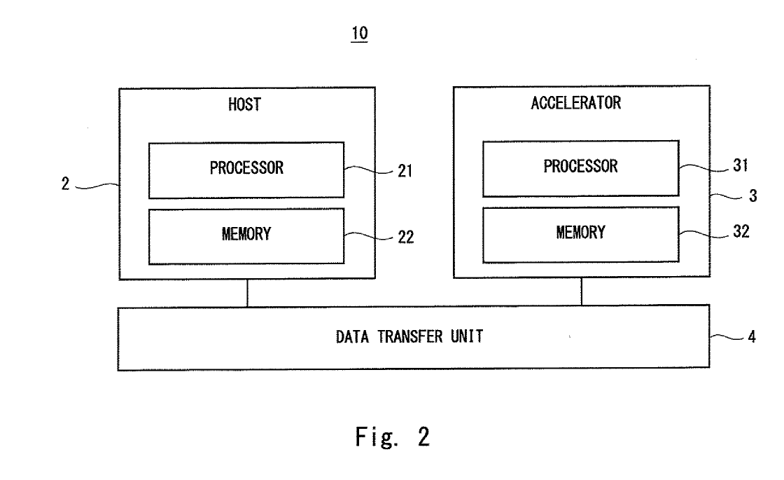

FIG. 2 is a block diagram showing one example of a schematic hardware configuration of a computer system according to a first exemplary embodiment of the present invention. A computer system 10 according to the first exemplary embodiment includes a host system (hereinafter referred to as a host) 2, an accelerator 3, and a data transfer unit 4 for transferring data between the host 2 and the accelerator 3. The host 2 includes a processor 21 and a memory 22 and the accelerator 3 includes a processor 31 and a memory 32.

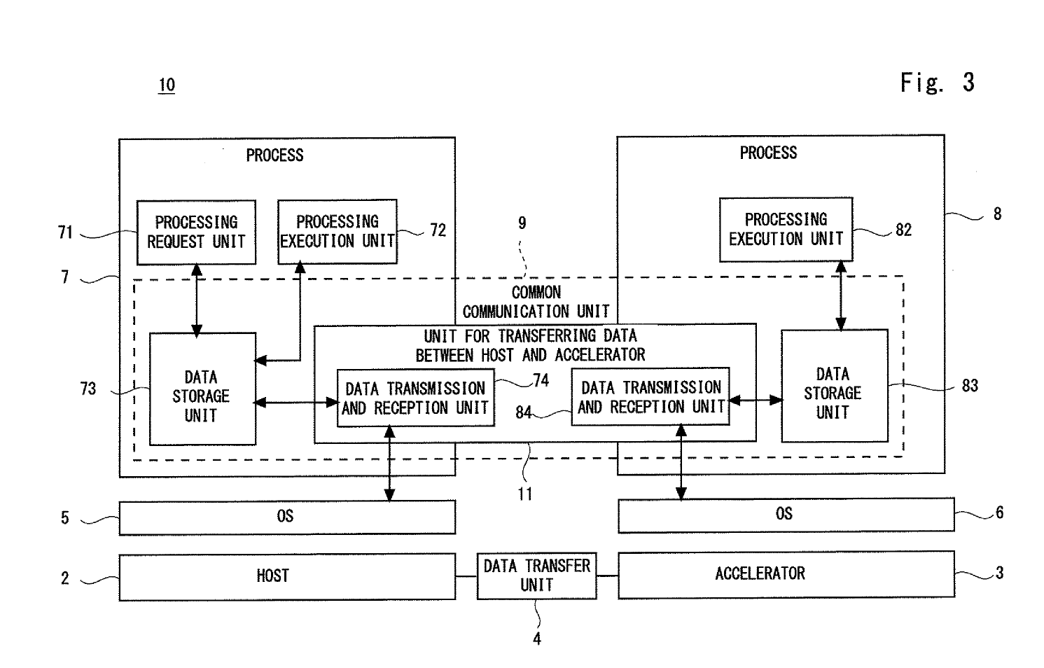

FIG. 3 is a block diagram showing one example of a schematic software configuration of the computer system according to the first exemplary embodiment. In the computer system 10 according to the first exemplary embodiment, an OS (Operating System) 5 and a process 7 are operated on the host 2 and an OS 6 and a process 8 are operated on the accelerator 3, and a common communication unit 9 connects the processes 7 and 8.

The OSs 5 and 6 each have a function of transferring data between the host 2 and the accelerator 3 using the data transfer unit 4 which is provided between the host 2 and the accelerator 3. Each of the OSs 5 and 6 is able to use the data transfer function through a user program or the like. While the OS 5 operated on the host 2 is different from the OS 6 operated on the accelerator 3, they may be the same OS.

The process 7 in the host 2 includes a processing request unit 71 for requesting processing, a processing execution unit 72 for executing processing, a data storage unit 73 for storing data, and a data transmission and reception unit 74 for transmitting and receiving data. Data storage units 73 and 83 and data transmission and reception units 74 and 84 of the host 2 and the accelerator 3 form the common communication unit 9.

The processing request unit 71 is one specific example of input means, and has a function of generating data which is to be processed by the processing execution unit 72. The processing request unit 71 also has a function of receiving data from outside the process 7 when generating data.

The processing execution unit 72 is one specific example of processing means, and has a function of executing processing of data. It is desirable for the processing execution unit 72 to have a function of concurrently processing a plurality of pieces of data. Typically, the processing request unit 71 and the processing execution unit 72 are implemented as threads that are independent from each other. Further, by implementing the processing execution unit 72 by a plurality of threads, a plurality of pieces of data can be processed at the same time.

The common communication unit 9 is one specific example of common communication means, and includes a data storage unit 73 in the host 2, a data storage unit 83 in the accelerator 3, and a unit for transferring data between the host and the accelerator (one specific example of data transfer means) 11 for transferring data between the host 2 and the accelerator 3. Further, the unit 11 for transferring data between the host and the accelerator includes a data transmission and reception unit in the host 2 (one specific example of data transmission and reception means) 74 and a data transmission and reception unit 84 in the accelerator 3.

The data storage units 73 and 83 are specific examples of storage means. The data storage units 73 and 83 are formed on the memory spaces of the processes 7 and 8, respectively, and each have a data writing function and a data reading function. Preferably, the data storage units 73 and 83 are able to store a plurality of pieces of data.

The data transmission and reception unit 74 of the host 2 has a function of reading data from the data storage unit 73 and calling for the OS 5 to transmit the data that is read out to the accelerator 3 through the unit 11 for transferring data between the host and the accelerator. The data transmission and reception unit 74 also has a function of storing data transmitted from the data transmission and reception unit 84 of the accelerator 3 in the data storage unit 73.

The process 8 in the accelerator 3 includes, similar to the process 7 in the host 2, a processing execution unit (one specific example of processing means) 82, a data storage unit 83, and a data transmission and reception unit (one specific example of data transmission and reception means) 84. Since the functions of the processing execution unit 82, the data storage unit 83, and the data transmission and reception unit 84 are substantially the same to the functions of the processing execution unit 72, the data storage unit 73, and the data transmission and reception unit 74 on the host 2, respectively, descriptions thereof will be omitted. Since processing is requested by the host 2 in the first exemplary embodiment, the process 8 in the accelerator 3 does not have a processing request unit.

Next, an operation of the computer system according to the first exemplary embodiment will be described in detail. First, the processing request unit 71 in the host 2 generates data to be processed in the processing execution unit 72 based on input data. Typically, the method of inputting data to the processing request unit 71 includes a case of inputting data from external connection means of the computer system 10 and a case of inputting data according to a user's instruction. However, it is not limited to these examples and an arbitrary method may be applied.

Next, the processing request unit 71 in the host 2 stores in the data storage unit 73 the data to be processed that is generated. When there are a plurality of pieces of data to be processed, the plurality of pieces of data to be processed are each stored in the data storage unit 73. The processing execution unit 72 then performs processing of reading the data to be processed stored in the data storage unit 73. When the data storage unit 73 stores a plurality of pieces of data to be processed, the processing execution unit 72 may retrieve new data to be processed to start processing before processing of the data to be processed that is retrieved first is ended.

To send back the results of processing executed by the processing execution unit 72 to the processing request unit 71, operations opposite to the above operations can be performed. At this time, data stored in the data storage unit 73 is configured in such a way that it can be identified from where and to where the data has been transmitted and the data is delivered to the correct transmission destination. For example, the data stored by the processing request unit 71 in the data storage unit 73 is formed to be retrieved only by the processing execution unit 72 or the data transmission and reception unit 74, and the data stored by the processing execution unit 72 or the data transmission and reception unit 74 in the data storage unit 73 is formed to be retrieved only by the processing request unit 71.

The data transmission and reception unit 74 in the host 2 retrieves the data that is stored in the data storage unit 73. The data transmission and reception unit 74 calls the OS 5, and instructs the OS 5 that is called to transmit the retrieved data to the accelerator 3. The OS 5 calls for the OS 6 on the accelerator 3 through the data transfer unit 4 that is provided between the host 2 and the accelerator 3 to transmit the data to be processed to the OS 6 that is called.

The OS 6 in the accelerator 3 transmits the received data to the data transmission and reception unit 84 in the accelerator 3. The data transmission and reception unit 84 in the accelerator 3 receives data from the OS 5 of the host 2, and stores the data in the data storage unit 83 in the accelerator 3. The processing execution unit 82 in the accelerator 3 reads out the data stored in the data storage unit 83 to execute processing.

When the data storage unit 73 in the host 2 stores a plurality of pieces of data, the data transmission and reception unit 74 in the host 2 may transmit each of the plurality of pieces of data that are stored to the accelerator 3. When the data storage unit 83 in the accelerator 3 stores a plurality of pieces of data, the processing execution unit 82 in the accelerator 3 may perform processing of retrieving new data before the processing of the data retrieved first from the data storage unit 83 is ended. It is desirable that the operation performed by the processing execution unit 72 in the host 2 and the operation performed by the processing execution unit 82 in the accelerator 3 be executed at the same time. This increases the total number of processing execution units which achieve concurrent execution and thus improves the processing performance.

Furthermore, the common communication unit 9 may have a function of allowing only the processing execution unit 72 in the host 2 to retrieve specific data stored in the data storage unit 73 to process the retrieved data. This allows only the processing execution unit 72 in the host 2 to execute specific data. In a similar way, the common communication unit 9 may have a function of allowing only the processing execution unit 82 in the accelerator 3 to process specific data.

As described above, with the computer system 10 according to the first exemplary embodiment, both cases of transmitting data from the processing request unit 71 in the host 2 to the processing execution unit 72 in the host 2 and transmitting data from the host 2 to the processing execution unit 82 in the accelerator 3 can be achieved by storing data in each of the data storage units 73 and 83 and retrieving data from each of the data storage units 73 and 83. Since the processing request unit 71 and the processing execution units 72 and 82 need not directly use the unit 11 for transferring data between the host and the accelerator, the program can be described more simply. In short, by simplifying the program of the computer system 10, it is possible to improve the productivity in the development of the program.

In the first exemplary embodiment described above, the accelerator 3 may further include a processing request unit. Since the accelerator 3 includes the processing request unit, new processing can be started on the accelerator 3.

### Second Exemplary Embodiment

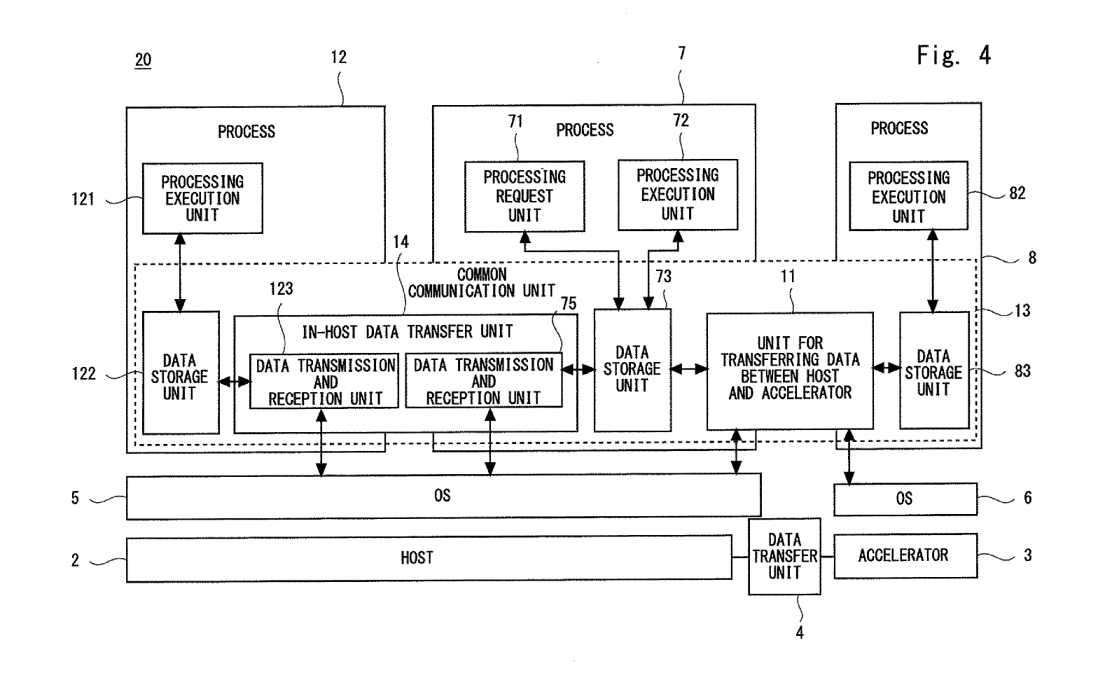

A hardware configuration of a computer system 20 according to a second exemplary embodiment of the present invention is substantially the same as the hardware configuration of the computer system 10 according to the first exemplary embodiment. FIG. 4 is a block diagram showing one example of a schematic software configuration of the computer system according to the second exemplary embodiment. In the computer system 20 according to the second exemplary embodiment, two processes 7 and 12 are present in the host 2 and a common communication unit 13 further includes an in-host data transfer unit 14.

The in-host data transfer unit 14 includes a data transmission and reception unit 75 in the process 7 and a data transmission and reception unit 123 in the process 12. The data transmission and reception units 75 and 123 of the in-host data transfer unit 14 have functions similar to those of the data transmission and reception units 74 and 84 of the unit 11 for transferring data between the host and the accelerator, and further have a function of transferring data to a data transmission and reception unit in another process in the host 2 using an inter-process communication function provided by the OSs 5 and 6. Since other configurations of the computer system 20 according to the second exemplary embodiment are substantially the same as those of the computer system 10 according to the first exemplary embodiment, detailed descriptions will be omitted.

The computer system 20 according to this exemplary embodiment achieves efficient processing using the plurality of processes 7 and 12 in the host 2. Further, just as the memory space used by the processes 7 and 12 in the host 2 is different from the memory space used by the process 8 in the accelerator 3, the memory space used by the process 7 in the host 2 is different from the memory space used by the process 12 in the host 2. It is therefore possible to check whether the program correctly operates when a plurality of memory spaces are used.

While in the second exemplary embodiment the configuration is described in which two processes 7 and 12 are present in the host 2, it is not limited to this example. It is also possible, for example, to provide a configuration in which three or more processes are present in the host 2 or a configuration in which a plurality of processes are present in the accelerator 3.

### Third Exemplary Embodiment

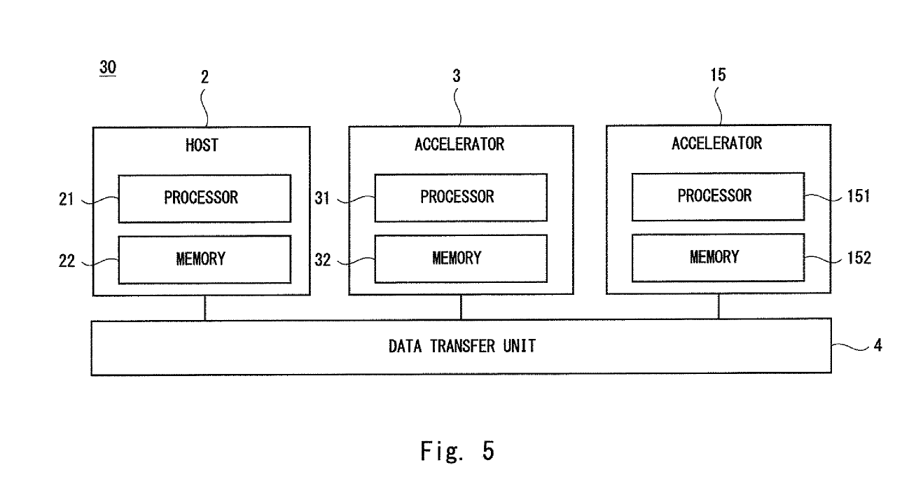

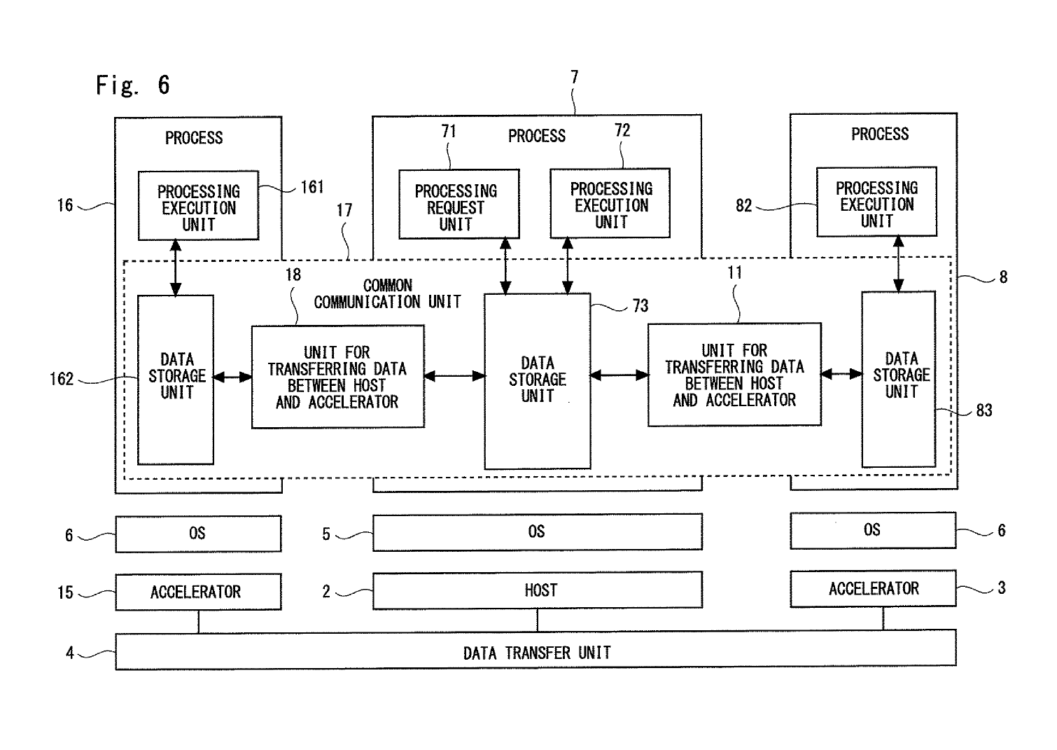

FIG. 5 is a block diagram showing one example of a schematic hardware configuration of a computer system 30 according to a third exemplary embodiment of the present invention. The computer system 30 according to the third exemplary embodiment includes a plurality of accelerators 3 and 15. FIG. 6 is a block diagram showing one example of a software configuration of the computer system according to the third exemplary embodiment of the present invention.

In the computer system 30 according to the third exemplary embodiment, a common communication unit 17 includes a plurality of units 11 and 18 for transferring data between the host and the accelerator. The data storage unit 73 in the host 2 and data storage units 83 and 162 in accelerators 3 and 15 are connected to each other through the plurality of units 11 and 18 for transferring data between the host and the accelerator. It is therefore possible, for example, for the processing request unit 71 in the host 2 to pass data to processing execution units 82 and 161 in the plurality of accelerators 3 and 15 through the common communication unit 17. Since other configurations of the computer system 30 according to the third exemplary embodiment are substantially the same as those of the computer system 10 according to the first exemplary embodiment, detailed descriptions thereof will be omitted.

With the computer system 30 according to the third exemplary embodiment, a plurality of accelerators can be used, thereby achieving a higher processing performance.

While in the third exemplary embodiment the configuration is provided in which two accelerators 3 and 15 are included, it is not limited to this example. A configuration in which three or more accelerators are included may be provided, for example.

Further, in the third exemplary embodiment, the common communication unit 17 may include a unit for transferring data between accelerators for transferring data directly between the data storage units 83 and 162 in the two accelerators 3 and 15. This enables direct data transmission and reception between the accelerators 3 and 15 without intervention of the host 2.

### Fourth Exemplary Embodiment

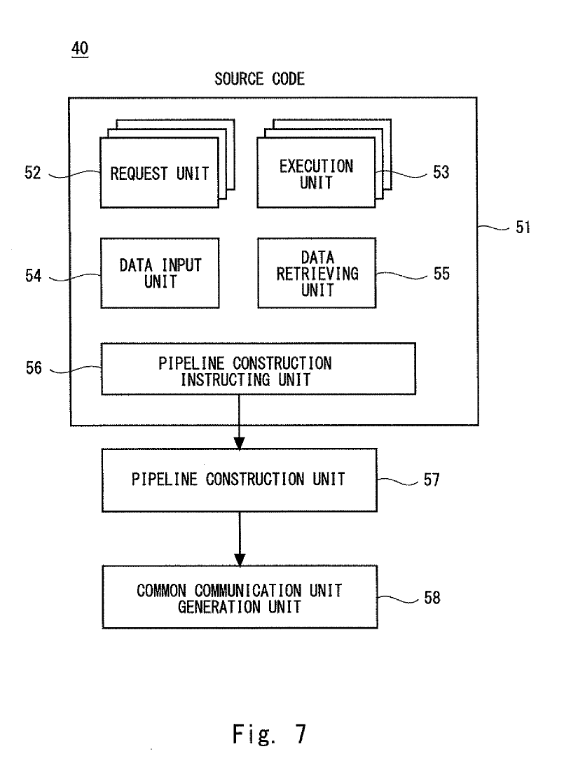

FIG. 7 is a block diagram showing one example of a schematic configuration of a computer system according to a fourth exemplary embodiment of the present invention. A computer system 40 according to the fourth exemplary embodiment also includes a source code 51 of a program to generate the processes 7 and 8 in the host 2 and the accelerator 3. In general, the processes 7 and 8 are generated by compiling the source code 51 and instructing the OSs 5 and 6 to execute an object.

The source code 51 of the processes 7 and 8 according to the fourth exemplary embodiment includes a request unit 52, an execution unit 53, a data input unit 54, a data retrieving unit 55, and a pipeline construction instructing unit 56.

The request unit 52 and the execution unit 53 are programs in which operations of the processing request unit 71 and the processing execution units 72 and 82 of the processes 7 and 8 are described, for example. The data input unit 54 and the data retrieving unit 55 are programs in which operations of inputting data to the data storage units 73 and 83 of the common communication unit 9 or retrieving data from the data storage units 73 and 83 are described, for example.

The pipeline construction instructing unit 56 instructs a pipeline construction unit 57 to construct a pipeline. The pipeline construction unit 57 is one specific example of pipeline construction means. The pipeline construction unit 57 is a program for connecting components of the request unit 52, the execution unit 53, the data input unit 54, the data retrieving unit 55 and the like to generate the processing request unit 71 and the processing execution units 72 and 82, and for connecting the processing request unit 71 and the processing execution units 72 and 82 that are generated through the common communication unit 9 to construct a pipeline. The pipeline construction unit 57 preferably has a function of constructing a pipeline based on a configuration file described by a user and the hardware configurations of the host 2 and the accelerator 3.

The computer system 40 according to the fourth exemplary embodiment further has a common communication unit generation unit 58 for generating the common communication unit 9 according to an instruction from the pipeline construction unit 57. The common communication unit generation unit 58 has a function of generating the data storage units 73 and 83 and the unit 11 for transferring data between the host and the accelerator forming the common communication unit 9.

Described next in detail is an operation of the pipeline construction unit constructing the pipeline, which is a characteristic operation of the computer system according to the fourth exemplary embodiment.

The pipeline construction unit 57 first instructs the common communication unit generation unit 58 to generate the data storage units 73 and 83. The pipeline construction unit 57 then connects the data input unit 54 and the data retrieving unit 55 to the data storage units 73 and 83 that are generated. This allows data transmission and reception between processes in the pipeline. The pipeline construction unit 57 then generates the unit 11 for transferring data between the host and the accelerator, and connects the data storage units 73 and 83 in the host 2 and the accelerator 3 to the unit 11 for transferring data between the host and the accelerator that is generated. This allows transmission and reception of data between pipeline processing in the host 2 and the accelerators 3.

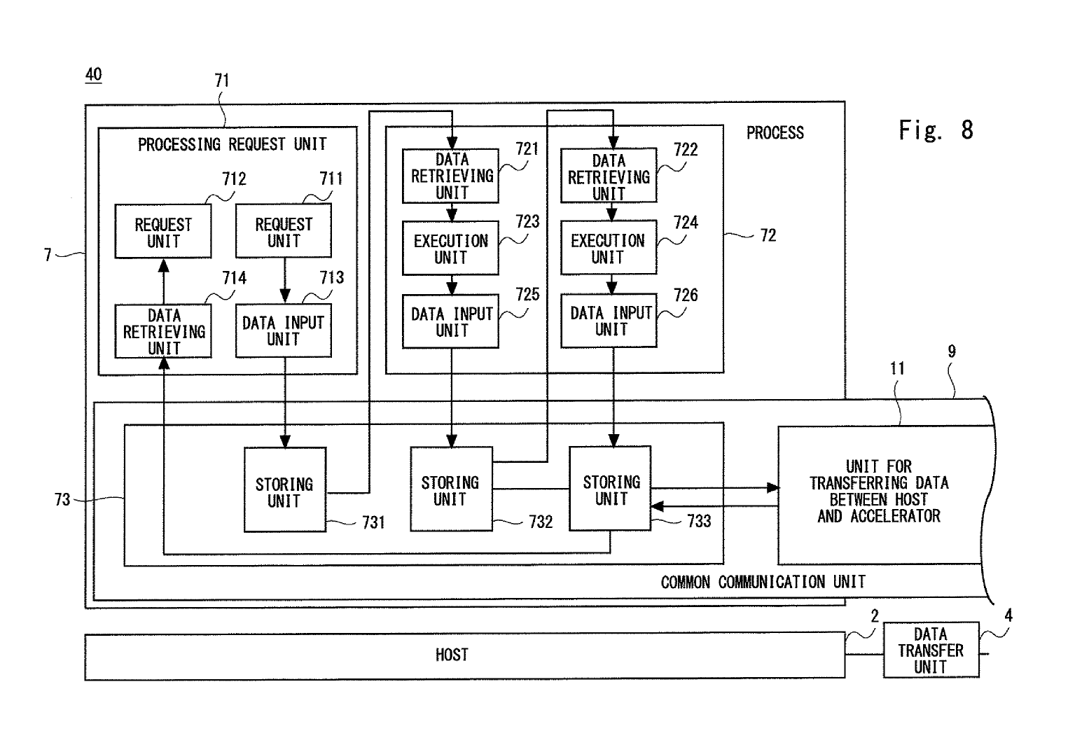

Described next is a specific pipeline configuration by the pipeline construction unit. FIG. 8 is a block diagram showing one example of a software configuration of the computer system according to the fourth exemplary embodiment including the processes 7 and 8 generated from the source code 51, and mainly shows a configuration of the host. The pipeline processing of the following data flow is executed in the host 2, for example; a request unit 711 generates data to transmit the data, execution units 723 and 724 process the data, and a request unit 712 receives the data at the last stage. Similar pipeline processing is executed in the accelerator 3 as well.

Since the hardware configuration of the computer system 40 according to the fourth exemplary embodiment is the same as that of the computer system 10 according to the first exemplary embodiment, detailed descriptions thereof will be omitted. The processing request unit 71 includes a request unit 711, a request unit 712, a data input unit 713, and a data retrieving unit 714. The pipeline construction unit 57 constructs the pipeline to achieve the connection relation as shown in FIG. 8. Meanwhile, the processing execution unit 72 includes an execution unit 723, an execution unit 724, a data input unit 725 and a data retrieving unit 721 connected to the execution unit 723, and a data input unit 726 and a data retrieving unit 722 connected to the execution unit 724. The pipeline construction unit 57 constructs the pipeline in order to achieve the connection relation as shown in FIG. 8.

The pipeline construction unit 57 generates, as shown in FIG. 8, three storing units 731, 732, and 733 in the host to connect the storing units 731, 732, and 733 as the data storage unit 73 of the common communication unit 9 so that pipeline processing is performed in the data flow described above. Each of the storing units 731, 732, and 733 has a function of storing data stored in the data storage unit 73. Due to the connection as described above, data flows through the request unit 711, the data input unit 713, the storing unit 731, the data retrieving unit 721, the execution unit 723, the data input unit 725, the storing unit 732, the data retrieving unit 722, the execution unit 724, the data input unit 726, the storing unit 733, the data retrieving unit 714, and the request unit 712 in this order.

In order to clearly describe the data flow between the processes, the plurality of storing units 731, 732, and 733 are used. The data input unit 713 and the data retrieving unit 721 are connected to the storing unit 731, the data input unit 725 and the data retrieving unit 722 are connected to the storing unit 732, and the data input unit 726 and the data retrieving unit 714 are connected to the storing unit 733. It is therefore possible to clearly distinguish from where and to where the data flows.

In this fourth exemplary embodiment, the method of distinguishing the data flow of the data storage unit 73 is not limited to the method described above. When one storing unit is used, for example, it is possible to distinguish the direction of data flow by tagging each piece of data stored in the storing unit. An arbitrary method may be applied.

The pipeline construction unit 57 further connects the unit 11 for transferring data between the host and the accelerator to the storing unit 732. It is therefore possible to transfer the data which is processed by the execution unit 723 to the accelerator 3 through the unit 11 for transferring data between the host and the accelerator. The pipeline construction unit 57 connects the unit 11 for transferring data between the host and the accelerator to the storing unit 733 so that the data received from the unit 11 for transferring data between the host and the accelerator is stored in the storing unit 733. The data processed by the execution unit on the accelerator 3 is thus passed to the request unit 712 through the storing unit 733 in the host 2.

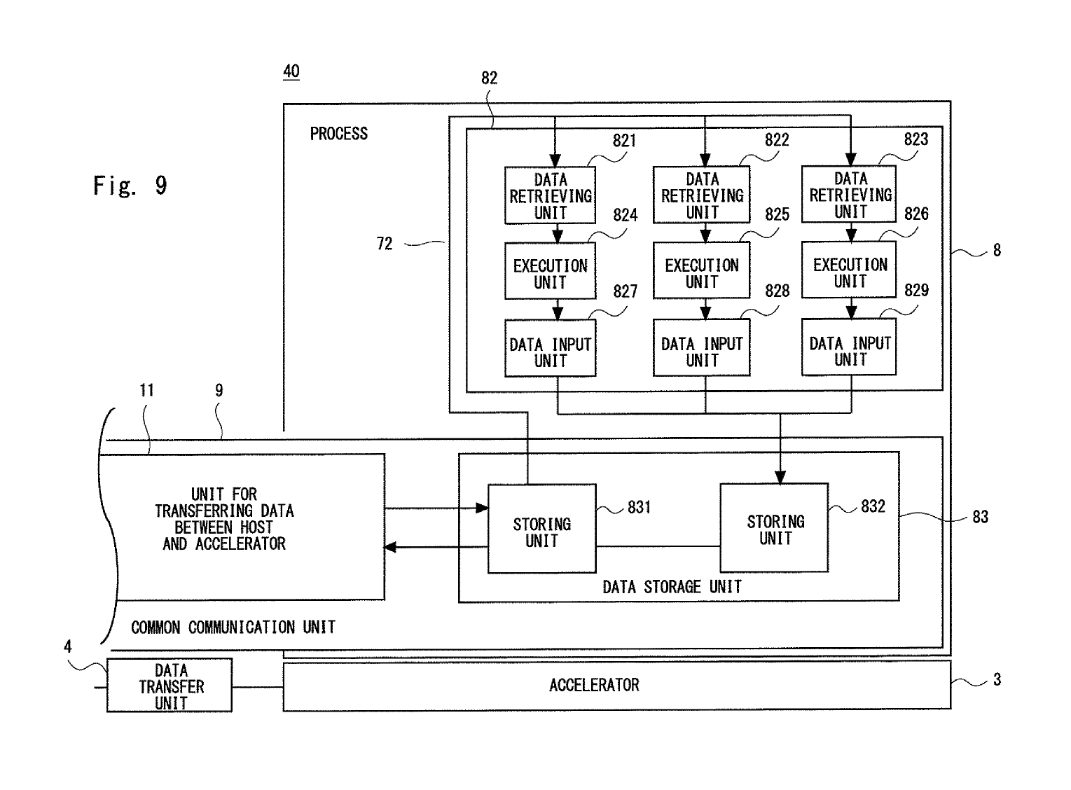

FIG. 9 is a block diagram showing one example of the software configuration of the computer system according to the fourth exemplary embodiment, and mainly shows a configuration of the accelerator. Only an execution unit 824 performs process execution in the accelerator 3. The pipeline construction unit 57 thus constructs the pipeline in the accelerator 3 in such a way that there is no processing request unit, the processing execution unit 82 includes three (multiple) execution units 824, 825, and 826, and the data storage unit 83 includes two storing units 831 and 832.

In this fourth exemplary embodiment, the pipeline construction unit 57 generates the plurality of execution units 824, 825, and 826. In this way, the accelerator 3 is able to allow the plurality of execution units 824, 825, and 826 to execute processing in parallel, thereby improving the processing performance. Since the connection between components is substantially the same as the connection in the host 2, the description thereof will be omitted.

As described above, with the computer system 40 according to the fourth exemplary embodiment, it is possible to construct the pipeline at the same time that the data processing is executed (when the program is executed). Further, based on the number of cores of the host processor 21 and the accelerator processor 31, appropriate pipeline components are constructed in each of the host 2 and the accelerator 3, and the pipeline components are connected by the common communication unit 9, whereby one pipeline may be constructed. This achieves the effect that there is no need to describe the source code which depends on the number of cores of the host processor 21 and the accelerator processor 31.

Furthermore, by using the accelerator 3 incorporating the processor 31 which has source code compatibility with the processor 21 of the host 2, the source code of the process for the host and the source code of the process for the accelerator can be made the same. This achieves the effect that the computer system 40 including the host 2 and the accelerator 3 having the single source code can be used and the productivity in the development of the program can be improved.

### Fifth Exemplary Embodiment

In a fifth exemplary embodiment of the present invention, an operation of the computer system 10 according to the first exemplary embodiment will be described with reference to more specific examples. FIG. 10 is a diagram for describing one example of pipeline processing of a computer system according to the fifth exemplary embodiment. This pipeline processing includes, for example, three processes: process A, a process B, and a process C.

The process A is a process of continuously receiving input data from outside the pipeline. The process A is, for example, a process for periodically reading image data from a camera connected to the computer system 10 to write the data into a memory. The process B is the core process of the pipeline processing, and is a process of executing a plurality of pieces of input data in parallel. The process B is, for example, a process for performing image recognition on the image data that is input. The process C is a process for receiving the results of the process B to externally output the results. The process C is, for example, a process for displaying the image recognition results on a display apparatus of the computer system.

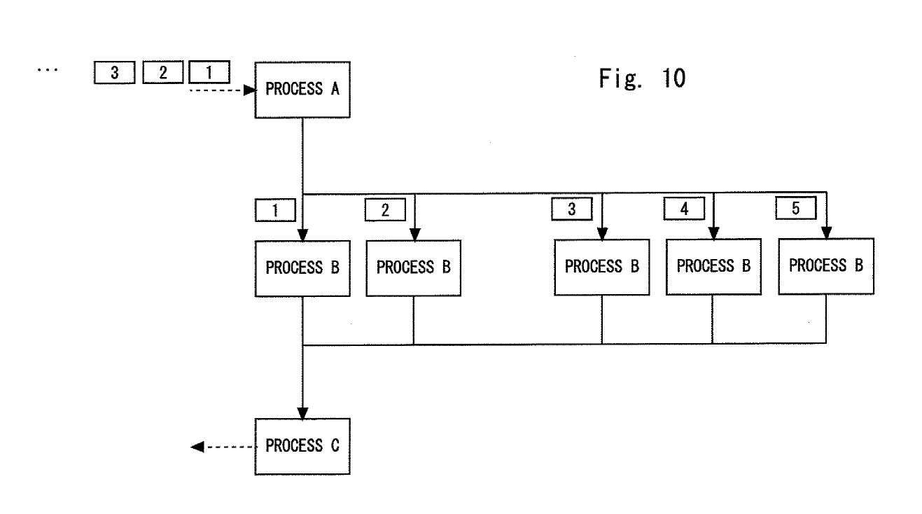

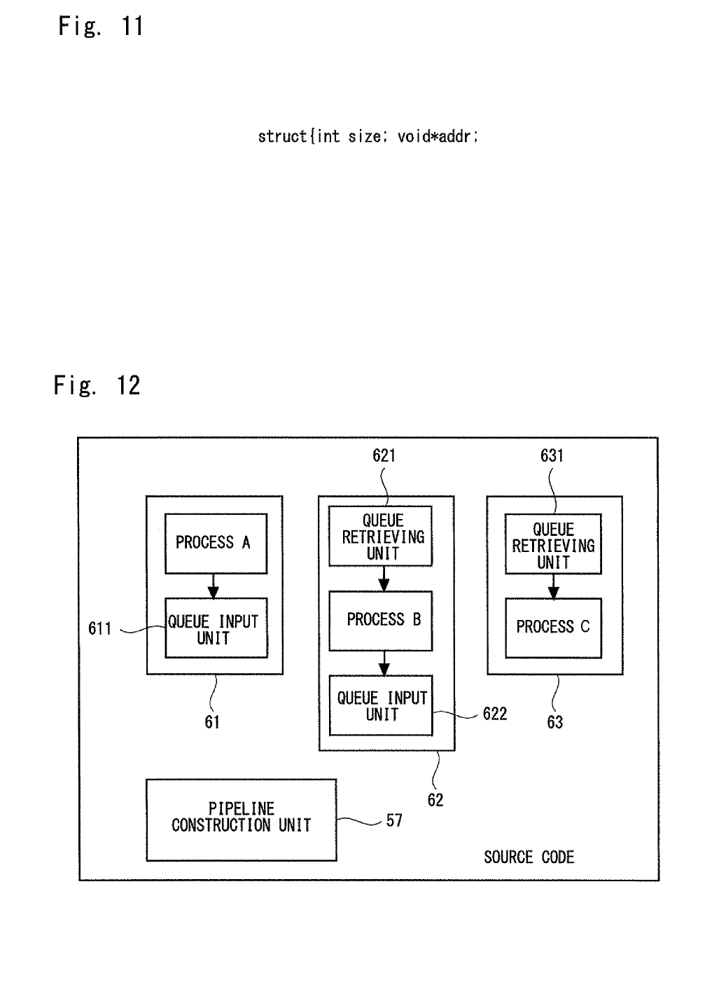

FIG. 11 is a diagram showing one example of a structure of data transferred between the process A and the process B in the C language structure. In this exemplary embodiment, for example, the structure used includes a size member indicating the data size and an addr member indicating the address in the memory storing data. A pointer to this structure is passed between the process A and the process B. Since a method of passing data between the process B and the process C is known, the description thereof will be omitted.

FIG. 12 is a diagram showing one example of a source code of a program used in the fifth exemplary embodiment. In this fifth exemplary embodiment, the host 2 and the accelerator 3 use the same source code, and a queue is used for data transfer between processes. The program according to the fifth exemplary embodiment includes four modules 57, 61, 62, and 63. The first module 61 includes the process A, and a queue input unit 611 for inputting data (a pointer to the structure) to a queue. The second module 62 includes a queue retrieving unit 621 for retrieving data from the queue, the process B, and a queue input unit 622. The third module 63 includes a queue retrieving unit 631 and the process C. The fourth module 57 is the pipeline construction unit 57 for configuring a pipeline by combining the three modules. The pipeline construction unit 57 has a function of generating threads to allocate the respective threads to the three modules 61, 62, and 63. One thread is allocated to each of the modules 61 and 63 including the process A and the process C and a plurality of (two) threads are allocated to the module 62 including the process B, whereby the process B is executed in parallel. Typically, the number of threads allocated to the module 62 including the process B is determined according to the number of cores of the host processor 21 or the accelerator processor 31. Note that methods used in the typical OS may be used as the specific method of generating threads and the method of allocating processes to the threads.

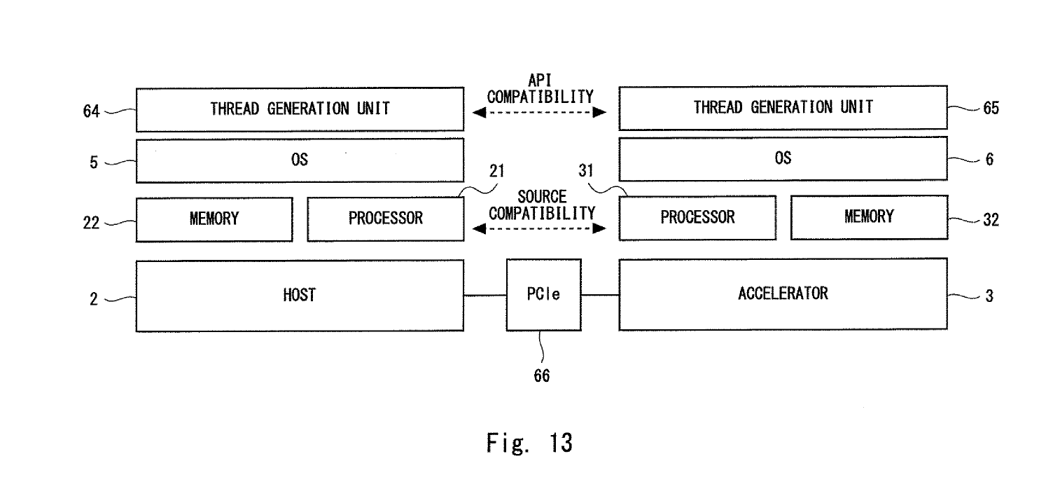

FIG. 13 is a diagram for describing the host and the accelerator according to the fifth exemplary embodiment. In the fifth exemplary embodiment, the accelerator 3 includes a processor 31 having source code compatibility with the host processor 21 and a thread generation unit 65 having API (Application Program Interface) compatibility with a thread generation unit 64 of the host 2. The host 2 and the accelerator 3 are connected by a PCIe (Peripheral Component Interconnect express) bus 66.

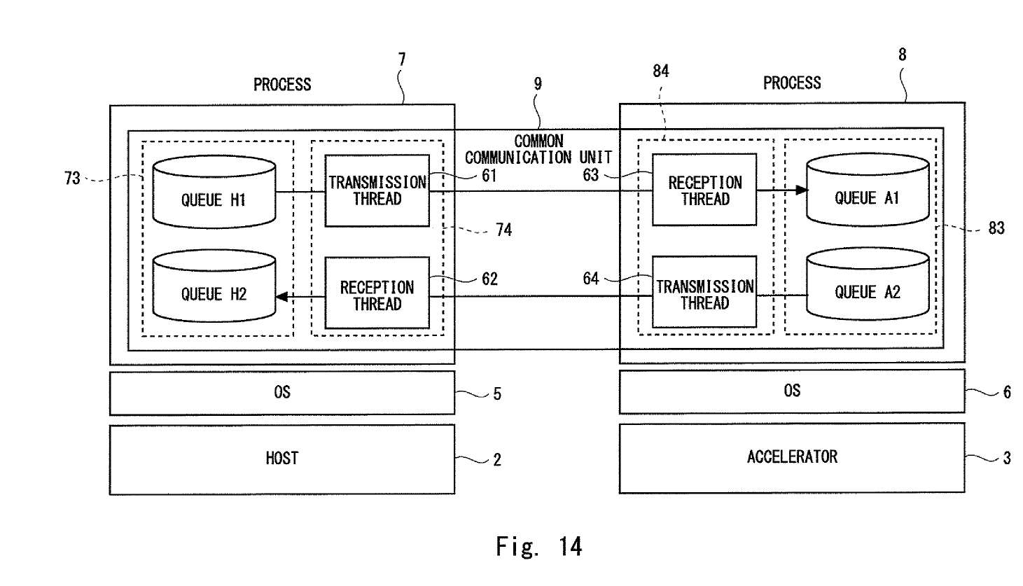

FIG. 14 is a diagram for describing the common communication unit according to the fifth exemplary embodiment. The common communication unit 9 according to the fifth exemplary embodiment includes queues H1, H2, A1, and A2 forming the data storage units 73 and 83, and transmission threads 61 and 64 and reception threads 62 and 63 forming the data transfer unit 4. The queues H1, H2, A1, and A2 are generated in memory spaces of the processes 7 and 8, and record data to be passed between processes. Since the data structure of the queues H1, H2, A1, and A2 is known, the explanation of the method of implementation will be omitted.

The data storage units 73 and 83 store data to be passed between the process A and the process B using two queues H1 and H2, and A1 and A2, respectively, and pass data between the process B and the process C. As described above, the queues H1, H2, A1, and A2 are created in the memory spaces of the processes 7 and 8. Thus, in order to pass data between the process A and the process B, for example, it is necessary to only store the pointer to the structure in the queues H1, H2, A1, and A2 and there is no need to store the data body in the queues H1, H2, A1, and A2. It is therefore possible to pass the data in the processes 7 and 8 with high speed, which leads to an increase in the processing speed.

The transmission thread 61 in the host 2 reads data from the queue H1, calls for a communication function between the host and the accelerator of the OS 5, and transmits the data that is read out to the reception thread 63 in the accelerator 3. Upon receiving the data, the reception thread 63 in the accelerator 3 stores the received data in the queue A1. While the pointer to the structure is stored in the queue A1, the transmission thread 61 transmits the data body which is in the range of the size byte based on the address indicated by the addr which is the structure member and the size which is the structure member instead of transmitting the pointer. This operation is the same as the known operation called data serialization. Meanwhile, the reception thread 63 receives the size and the data body, stores the size and the data body in the structure, and stores the pointer of the structure in the queue A1. This operation is the same as the known operation called data deserialization.

As described above, the transmission threads 61 and 64 perform serialization and the reception threads 62 and 63 perform deserialization. The serialization or the deserialization is performed only when data is transferred between the host 2 and the accelerator 3. There is no need to perform the serialization or the deserialization when data is transmitted and received in the host 2 or the accelerator 3, thereby reducing the overhead of data transmission and reception.

Further, the process A, the process B, and the process C are able to transfer data by data input to the queues H1, H2, A1, and A2 and data retrieval from the queues H1, H2, A1, and A2. This eliminates the need to differentiate the case in which the data transfer destination and the data source are in the same process 7 or 8 from the case in which they are in the different processes 7 and 8, which can simplify the program for the processing unit.

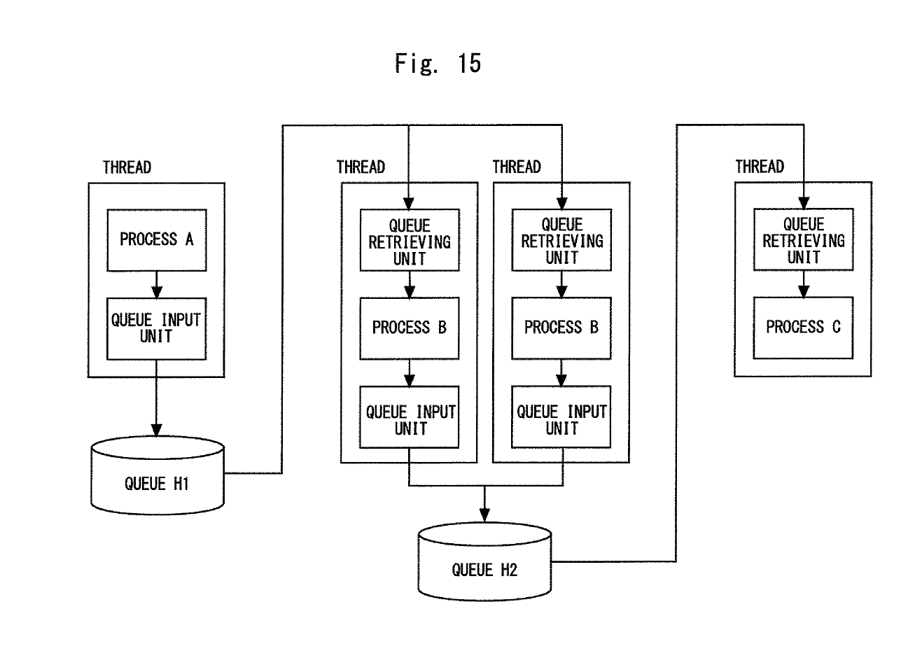

FIG. 15 is a diagram showing one example of a pipeline configured during the process in the host by the pipeline construction unit according to the fifth exemplary embodiment. In the fifth exemplary embodiment, four threads are generated. Each of the process A and the process C is allocated to one thread, and the process B is allocated to two threads so as to execute the process B by two threads in parallel. The process A and the process B are connected through the queue H1, and the process B and the process C are connected through the queue H2.

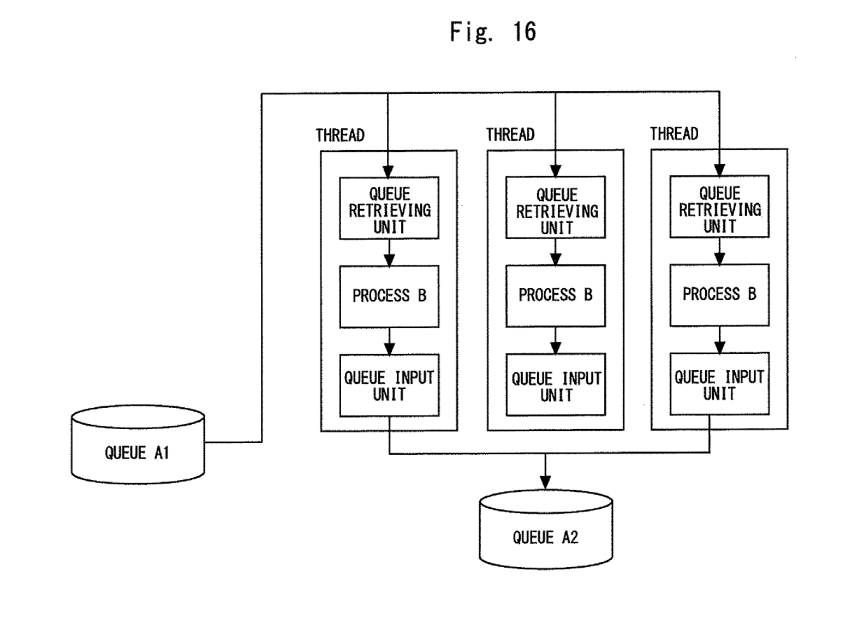

FIG. 16 is a diagram showing one example of a pipeline constructed during the process in the accelerator. Since the process A and the process C are executed only in the host 2 in the fifth exemplary embodiment, three threads which execute the process B are generated in the process 8 in the accelerator 3.

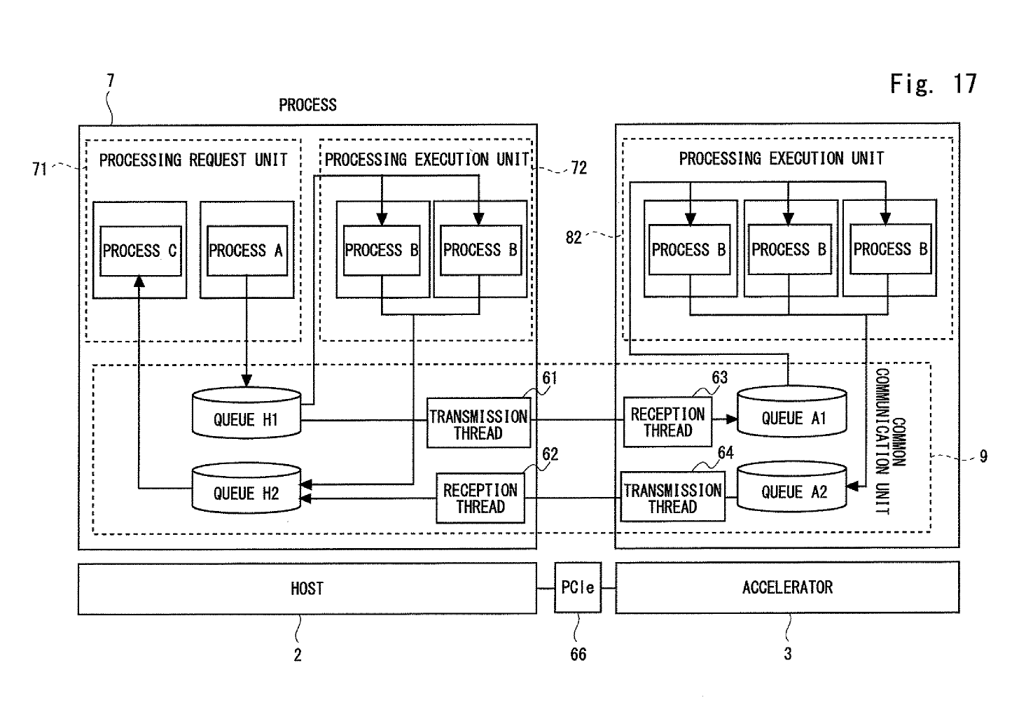

FIG. 17 is a diagram showing one example of a whole connection configuration of the computer system according to the fifth exemplary embodiment. In FIG. 17, in order to avoid cluttering the figure, some known components are omitted. The queue H1 and the queue A1 are connected so that they are used for data transfer from the process A to the process B. The queue H2 and the queue A2 are connected so that they are used for data transfer from the process B to the process A. In this way, the data storage units 73 and 83 have the function of distinguishing from where and to where the data to be stored flows by using the two queues H1 and H2, and A1 and A2, respectively.

Next, a characteristic operation of the computer system according to the fifth exemplary embodiment described above will be described in more detail. Since the processing of storing data in a queue is known, the description thereof will be omitted.

Described first is an operation in a case in which data is passed from the process A to the process B in the data transfer between the host 2 and the accelerator 3. In this fifth exemplary embodiment, the operation is performed in the procedure described below.

The reception thread 63 in the accelerator 3 checks the number of pieces of data stored in the queue A1. When the number of pieces of data stored in the queue A1 is equal to or less than a certain number, the reception thread 63 transmits a request to the transmission thread 61 in the host 3. The reception thread 63 is able to send the request using the unit 11 for transferring data between the host and the accelerator included in the accelerator 3. As described above, in the fifth exemplary embodiment, the host 2 and the accelerator 3 are connected by the PCIe bus 66. Therefore, typically, the unit 11 for transferring data between the host and the accelerator includes the PCIe bus 66, a driver software of the PCIe bus 66 included in the OS, and a library which calls for the driver software.

Upon receiving the request from the reception thread 63, the transmission thread 61 in the host 2 retrieves a predetermined number of pieces of data from the queue H1. When the number of pieces of data stored in the queue H1 is equal to or less than the predetermined number, the transmission thread 61 retrieves the same number of pieces of data as the number of pieces of data that is stored. Further, when data is not stored in the queue H1, the transmission thread 61 waits until data is stored in the queue H1. The transmission thread 61 serializes the data retrieved from the queue H1. The transmission thread 61 transfers the serialized data to the accelerator 3 using the unit 11 for transferring data between the host and the accelerator. The reception thread 63 receives the data from the unit 11 for transferring data between the host and the accelerator, deserializes the data, and stores the deserialized data in the queue A1. Since the operation of passing data from the process B to the process C is substantially similar to the operation of passing data from the process A to the process B, the description thereof will be omitted.

The aforementioned operations are performed completely independently from the operations of the processing request unit 71 and the processing execution units 72 and 83. The processing request unit 71 and the processing execution units 72 and 83 thus do not have to differentiate the operation in the case of passing data between threads in the processes 7 and 8 from the operation in the case of passing data between the host 2 and the accelerator 3, and both operations are the same: data input to the queue or data retrieval from the queue. Further, in the fifth exemplary embodiment, the processor 31 of the accelerator 3 has source code compatibility with the host processor 21. Therefore, data transfer in the processes 7 and 8 and between the host 2 and the accelerator 3 can be described using the same source code, which simplifies the program.

In the fifth exemplary embodiment, the request is sent from the reception threads 62 and 63 to the transmission threads 61 and 64 to start data transfer between the host and the accelerator. However, the operation of data transfer is not limited to this example. The operation of data transfer between the host and the accelerator may be different. Such an operation may be applied, for example, in which the number of pieces of data transmitted to the accelerator 3 and the number of pieces of data received from the accelerator 3 are counted, and a certain number of pieces of data are constantly processed in the accelerator 3. This eliminates the request from the reception threads 62 and 63 to the transmission threads 61 and 64, and thus the effects of a simplified implementation and reduced transfer overhead can be expected.

Described next is a typical operation in a case in which the thread which has executed the process A inputs five pieces of data to the queue H1 in order to describe the effect in terms of performance according to the fifth exemplary embodiment.

In this operation, it is assumed that all the queues are empty when data is input to the queue H1.

When data is input to the queue H1, one thread among threads including the process B in the host 2 retrieves the data from the queue H1 to start the process B on the data. Since the time of executing the process B is long in the fifth exemplary embodiment, as is similar to the first thread, the second thread also retrieves data from the queue H1 to start the process B before the processing of one thread is completed.

Before the two processes are ended, data is transferred between the host 2 and the accelerator 3, and three pieces of data remaining in the queue H1 are transferred to the accelerator 3 and are input to the queue A1. Since the operation in which the thread allocated to the process B in the accelerator 3 retrieves data from the queue A1 to start the processing is similar to the operation in the host 2, the description thereof will be omitted.

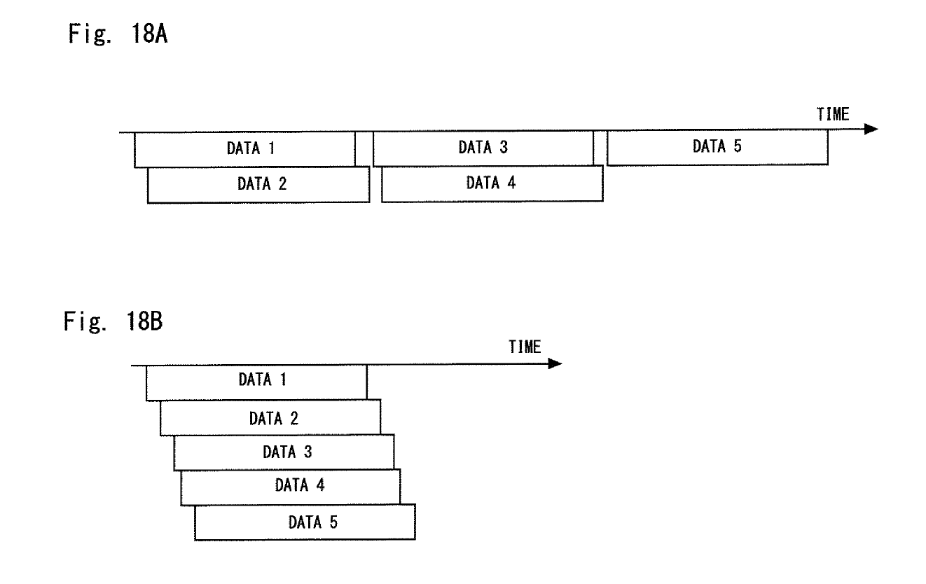

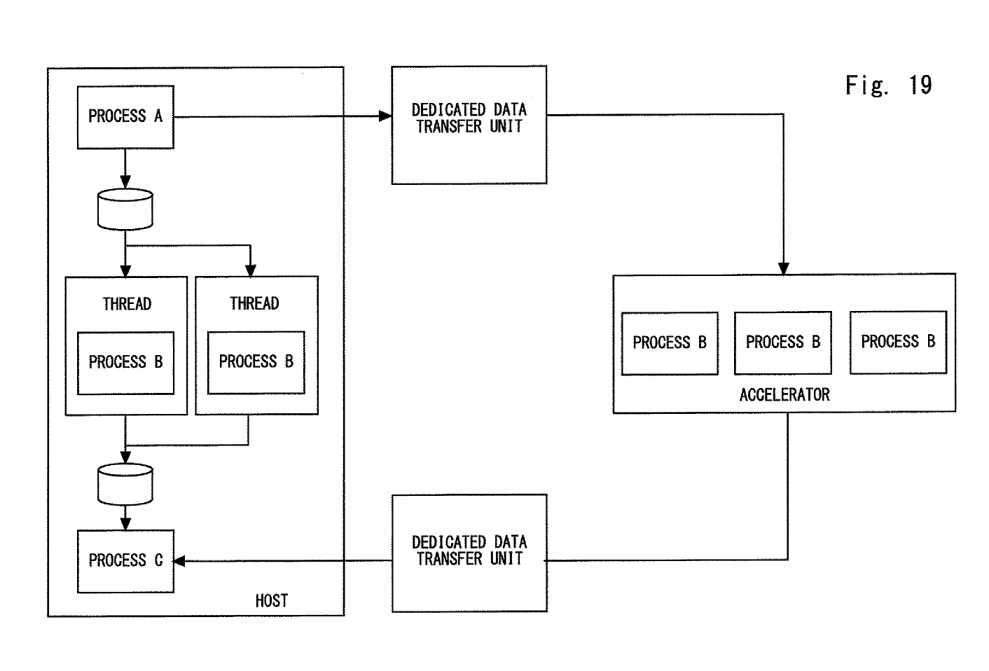

Due to the above operation, five pieces of data are processed in parallel by the two threads in the host 2 and the three threads in the accelerator 3. Compared to the case in which five pieces of data are processed by two threads only in the host 2 as shown in FIG. 18A, five pieces of data can be processed in parallel by the five threads in the host 2 and the accelerator 3 according to the fifth exemplary embodiment as shown in FIG. 18B. This reduces time until the completion of the processing and improves the throughput.

It is also possible, in the fifth exemplary embodiment, to generate the common communication unit 9 using a library. This library corresponds to the common communication unit generation unit 58 of the fourth exemplary embodiment. The library includes a function of generating the queues H1, H2, A1, and A2, the transmission threads 61 and 64, and the reception threads 62 and 63 based on the instructions from the pipeline construction unit 57, and a function of connecting the components H1, H2, A1, A2, 61, 62, 63, and 64 based on the instructions from the pipeline construction unit 57.

Further, in order to allow the user program of the library to specify the structure of data stored in the queues H1, H2, A1, and A2, the library also has a function of receiving a serializer that performs serialization and a deserializer that performs deserialization from the user program when generating the transmission threads 61 and 64 or the reception threads 62 and 63. In a typical example, the library receives a callback function from a user program. By employing the configuration in which the common communication unit 9 is generated from the library, it is possible to easily create the common communication unit 9 according to the pipeline configuration compared to the case in which it is independently developed.

The present invention is not limited to the embodiments stated above, but may be changed as appropriate without departing from the spirit of the present invention.

Furthermore, in the above embodiments, each processing may be achieved by causing a CPU to execute a computer program, as described above.

The program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM, CD-R, CD-R/W, and semiconductor memories (such as mask ROM, PROM (Programmable ROM), EPROM (Erasable PROM), flash ROM, RAM, etc.).

The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While a part or all of the aforementioned exemplary embodiments may be described as shown in the following Supplementary notes, it is not limited to them.

### (Supplementary Note 1)

A computer system comprising:

host means comprising storage means and processing means, the storage means storing data and the processing means processing the stored data; and

extension means connected to the host means to extend functionality of the host means, the extension means comprising storage means and processing means, the storage means storing data and the processing means processing the stored data, wherein

the computer system comprises common communication means, the common communication means having a function of passing data between threads in the host means and a function of passing data between a thread in the host means and a thread in the extension means.

### (Supplementary Note 2)

The computer system according to (Supplementary note 1), wherein the common communication means comprises:

the storage means formed in a memory space of a process in the host means;

the storage means formed in a memory space of a process in the extension means; and

data transfer means for connecting the storage means of the host means and the storage means of the extension means.

### (Supplementary Note 3)

The computer system according to (Supplementary note 2), wherein the storage means comprises a queue, the queue being generated in the memory space of the process and recording data to be passed between processes.

### (Supplementary Note 4)

The computer system according to (Supplementary note 2) or (Supplementary note 3), wherein the data transfer means comprises:

data transmission and reception means in the host means, the data transmission and reception means transmitting and receiving data to and from the storage means in the host means; and

data transmission and reception means in the extension means, the data transmission and reception means transmitting and receiving data to and from the storage means of the extension means and the data transmission and reception means of the host means.

### (Supplementary Note 5)

The computer system according to any one of (Supplementary note 1) to (Supplementary note 4), further comprising pipeline construction means for connecting processes in pipeline processing by the common communication means.

### (Supplementary Note 6)

The computer system according to (Supplementary note 5), wherein the pipeline construction means connects, at the time of data process execution, depending on the number of processor cores of each of the host means and the extension means, the processes to generate the processing means and input means to which data is input, and connects, by the common communication means, the processing means and the input means that are generated to construct a pipeline.

### (Supplementary Note 7)

The computer system according to (Supplementary note 6), wherein the pipeline construction means connects with one another, at the time of the data process execution, depending on the number of processor cores of each of the host means and the extension means, a request unit for requesting processing, an execution unit for executing processing, a data input unit for inputting data to the storage means, and a data retrieving unit for retrieving data from the storage means to generate the processing means and the input means, and connects, by the common communication means, the processing means and the input means that are generated to construct a pipeline.

### (Supplementary Note 8)

The computer system according to any one of (Supplementary note 1) to (Supplementary note 7), wherein the extension means is an accelerator comprising a processor having source code compatibility with a processor of the host means.

### (Supplementary Note 9)

The computer system according to (Supplementary note 8), wherein the extension means and the host means use the same source code.

### (Supplementary Note 10)

The computer system according to (Supplementary note 5), further comprising common communication generation means for generating the storage means and the data transfer means according to an instruction from the pipeline construction means to generate the common communication means based on the storage means and the data transfer means that are generated.

### (Supplementary Note 11)

A method of processing a computer system, the computer system comprising:

host means comprising storage means and processing means, the storage means storing data and the processing means processing the stored data; and

extension means connected to the host means to extend functionality of the host means, the extension means comprising storage means and processing means, the storage means storing data and the processing means processing the stored data, the method comprising:

passing data between threads in the host means; and

passing data between a thread in the host means and a thread in the extension means.

### (Supplementary Note 12)

The method of processing the computer system according to (Supplementary note 11), the method comprising the steps of:

forming the storage means in a memory space of a process in the host means;

forming the storage means in a memory space of a process in the extension means; and

connecting the storage means of the host means and the storage means of the extension means.

### (Supplementary Note 13)

The method of processing the computer system according to (Supplementary note 12), comprising forming the storage means as a queue, the queue being generated in the memory space of the process and recording data to be passed between processes.

### (Supplementary Note 14)

The method of processing the computer system according to (Supplementary note 12) or (Supplementary note 13), the method comprising the steps of:

transmitting and receiving data to and from the storage means in the host in the host means; and

transmitting and receiving data to and from the host means and the storage means of the extension means.

### (Supplementary Note 15)

The method of processing the computer system according to any one of (Supplementary note 11) to (Supplementary note 14), the method comprising the step of connecting processes in pipeline processing.

### (Supplementary Note 16)

The method of processing the computer system according to (Supplementary note 15), comprising the step of connecting, at the time of data process execution, depending on the number of processor cores of each of the host means and the extension means, the processes to generate the processing means and input means to which data is input, and connecting the processing means and the input means that are generated to construct a pipeline.

### (Supplementary Note 17)

The method of processing the computer system according to (Supplementary note 16), comprising the step of connecting with one another, at the time of the data process execution, depending on the number of processor cores of each of the host means and the extension means, a request unit for requesting processing, an execution unit for executing processing, a data input unit for inputting data to the storage means, and a data retrieving unit for retrieving data from the storage means to generate the processing means and the input means, and connecting the processing means and the input means that are generated to construct a pipeline.

### (Supplementary Note 18)

A program of a computer system, the computer system comprising:

host means comprising storage means and processing means, the storage means storing data and the processing means processing the stored data; and

extension means connected to the host means to extend functionality of the host means, the extension means comprising storage means and processing means, the storage means storing data and the processing means processing the stored data, the program causing a computer to execute the following processing of:

passing data between threads in the host means; and

passing data between a thread in the host means and a thread in the extension means.

This application is based upon and claims the benefit of priority from Japanese Patent Application No. 2012-041900, filed on Feb. 28, 2012, the disclosure of which is incorporated herein in its entirety by reference.

### INDUSTRIAL APPLICABILITY

The present invention is applicable, for example, to a computer system for consecutively executing image processing of image data input from a plurality of cameras with a high performance and low cost.

### REFERENCE SIGNS LIST

2 HOST
3 ACCELERATOR
4 DATA TRANSFER UNIT
5, 6 OS
7, 8 PROCESSES
9 COMMON COMMUNICATION UNIT
10, 20, 30, 40 COMPUTER SYSTEM
11 UNIT FOR TRANSFERRING DATA BETWEEN HOST AND ACCELERATOR
71 PROCESSING REQUEST UNIT
72, 82 PROCESSING EXECUTION UNITS
73, 83 DATA STORAGE UNIT
74, 84 DATA TRANSMISSION AND RECEPTION UNIT
110 HOST MEANS
111, 121 STORAGE MEANS
112, 122 PROCESSING MEANS
120 EXTENSION MEANS
130 COMMON COMMUNICATION MEANS

What is claimed is:

1.-10. (canceled)

11. A computer system comprising:
a host comprising a storage and a processing portion, the storage storing data and the processing portion processing the stored data; and
an extension portion connected to the host to extend functionality of the host, the extension portion comprising a storage and a processing portion, the storage storing data and the processing portion processing the stored data, wherein
the computer system comprises a common communication portion, the common communication portion having a function of passing data between threads in the host and a function of passing data between a thread in the host and a thread in the extension portion.

12. The computer system according to claim 11, wherein the common communication portion comprises:
the storage formed in a memory space of a process in the host;
the storage formed in a memory space of a process in the extension portion; and
a data transfer portion for connecting the storage of the host and the storage of the extension portion.

13. The computer system according to claim 12, wherein the storage comprises a queue, the queue being generated in the memory space of the process and recording data to be passed between processes.

14. The computer system according to claim 12, wherein the data transfer portion comprises:
a data transmission and reception portion in the host, the data transmission and reception portion transmitting and receiving data to and from the storage in the host; and
a data transmission and reception portion in the extension portion, the data transmission and reception portion transmitting and receiving data to and from the storage of the extension portion and the data transmission and reception portion of the host.

15. The computer system according to claim 11, further comprising a pipeline construction portion for connecting processes in pipeline processing by the common communication portion.

16. The computer system according to claim 15, wherein the pipeline construction portion connects, at time of data process execution, depending on the number of processor cores of each of the host and the extension portion, the processes to generate the processing portion and an input portion to which data is input, and connects, by the common communication portion, the processing portion and the input portion that are generated to construct a pipeline.

17. The computer system according to claim 16, wherein the pipeline construction portion connects with one another, at time of the data process execution, depending on the number of processor cores of each of the host and the extension portion, a request unit for requesting processing, an execution unit for executing processing, a data input unit for inputting data to the storage, and a data retrieving unit for retrieving data from the storage to generate the processing portion and the input portion, and connects, by the common communication portion, the processing portion and the input portion that are generated to construct a pipeline.

18. The computer system according to claim 11, wherein the extension portion is an accelerator comprising a processor having source code compatibility with a processor of the host.

19. A method of processing a computer system, the computer system comprising:
a host comprising a storage and a processing portion, the storage storing data and the processing portion processing the stored data; and
extension portion connected to the host to extend functionality of the host, the extension portion comprising a storage and a processing portion, the storage storing data and the processing portion processing the stored data, the method comprising:
passing data between threads in the host; and
passing data between a thread in the host and a thread in the extension portion.

20. A computer readable medium storing a program of a computer system, the computer system comprising:
a host comprising a storage and a processing portion, the storage storing data and the processing portion processing the stored data; and
a extension portion connected to the host to extend functionality of the host, the extension portion comprising a storage and a processing portion, the storage storing data and the processing portion processing the stored data, the program causing a computer to execute the following processing of:
passing data between threads in the host; and
passing data between a thread in the host and a thread in the extension portion.
